(19) United States
(12) Patent Application Publication
(10) Pub. No.: US 2024/0270134 A1
(43) Pub. Date: Aug. 15, 2024

(54) Support element for a lumbar support device, lumbar support device, and seat having a lumbar support device

(71) Applicant: Gentherm Präzision SE, Treuchtlingen (DE)

(72) Inventors: Berthold Bocsanyi, Treuchtlingen (DE); Jens Donat, Treuchtlingen (DE); Erich Dörfler, Treuchtlingen (DE); Ronny Gehlmann, Treuchtlingen (DE)

(21) Appl. No.: 18/433,542

(22) Filed: Feb. 6, 2024

(30) Foreign Application Priority Data
Feb. 10, 2023 (DE) 10 2023 103 341.7

(51) Int. Cl. B60N 2/66

(52) U.S. Cl. CPC B60N 2/665; B60N 2205/30

(57) ABSTRACT

A support element for a lumbar support device that includes: a plate-like body having a first side and an opposing second side, the first side supports at least one air cushion that can be filled with air, and at least one attaching device for the at least one air cushion, the first side of the support element has a surface structure having a mean roughness Ra between 0.4 μm and 20 μm in a first region and/or or a surface modification that reduces static friction.

### CROSS REFERENCE TO RELATED APPLICATIONS

This application claims priority to DE 10 2023 103 341.7 filed on Feb. 10, 2023, the entirety of which is hereby incorporated by reference herein for all purposes.

### FIELD

The invention relates to a support element for a lumbar support device, a lumbar support device, and a seat having a lumbar support device.

### BACKGROUND

According to the prior art, lumbar support devices that comprise a plate-like support element and at least one air cushion are known. The plate-like support element acts as a support for the at least one air cushion. The air cushion moves relative to the support element when the air cushion is being filled and emptied. In order to avoid the so-called slip-stick effect, it is common to arrange a layer of a material on which the air cushion or cushions can slide well on the support element. It is known in particular to use felt or fleece to this end.

The known solution has the drawback that by using felt or fleece as a cover layer, a material that is different from the support element in terms of the material employed is used that, in the case of recycling, leads to increased complexity due to the required separation according to materials. In addition, such a cover layer involves increased complexity during assembly and thus increased materials and operations costs.

The object of the invention is to alleviate the aforesaid drawbacks, at least in part.

### SUMMARY

In terms of the support element, the object of the invention is attained using the subject matter of claim 1, in terms of the lumbar support device using the subject matter of claim 9, and in terms of the seat using the subject matter of claim 10. Useful embodiments result from each of the subordinate claims.

The inventive support element for a lumbar support device comprises a plate-like body having a first side and an opposing second side, wherein the first side supports at least one air cushion that can be filled with air. The support plate has at least one attaching device for the at least one air cushion.

The first side of the support element has a surface structure having a mean roughness Ra between 0.4 μm and 20 μm at least in one first region. Alternatively, or in addition, the first region has a surface modification that reduces static friction.

The first region shall be understood to be a region in which the air cushion, or a casing of the air cushion, with which the first side of the support element can be in contact when assembled. The inventive surface properties of the mean roughness Ra between 4 μm and 20 μm are provided, for example, by surfaces having a surface structure according to VDI 3400 Ref. 12 through 45. The surface structure can have uniformly structured unevennesses, e.g. in the form of a repeating pattern, or randomly distributed unevennesses. The surface structure usefully has a maximum roughness depth between 1.6 μm and 65 μm.

“Surface roughness” shall be understood to be a structuring, post-treatment, or coating of the surface of the plate-like body, wherein the plate-like body is in one piece prior to and following the surface modification.

The surface structure is in particular embodied in one piece with the plate-like body.

The surface structure usefully has a roughness between 1 μm and 20 μm, in particular between 5 μm and 15 μm, in particular between 8 μm and 10 μm. In particular, the surface structure has a maximum roughness depth between 18.5 μm and 65 μm, in particular between 30 μm and 45 μm. According to the invention, this may be a surface structure, for example, according to VDI 3400 Ref. 38 through 40.

When embodied, the support element is formed from a plastic injection molded part. In particular, this is a one-component injection molded part or a one-piece molded part that has a unform material composition. This may be polypropylene, for example, or even other plastics suitable for the injection molding process that the person skilled in the art is familiar with. For manufacture, in particular an injection mold having a suitable surface structuring may be used. Alternatively, a surface structuring may also be added subsequently.

In one further embodiment, the first side of the support element has an equal mean roughness Ra in the first region and at least in part, in particular entirely, in a second region. A second region is the region of the surface of the first side that normally does not come into contact with the air cushion, i.e. a casing of the air cushion.

When embodied, the support element is designed for attaching a plurality of air cushions, e.g. two air cushions, three air cushions, or more air cushions, that are arranged in particular in a row. In particular an attaching device or a pair of attaching devices are provided for attaching each air cushion.

In one further embodiment, the support element has one or a plurality of guide elements, in particular for guiding lines to be connected to the air cushion(s).

Moreover, the support element can comprise one or a plurality of further attaching devices for adding further components of a lumbar support device and/or clips.

The inventive lumbar support device comprises an inventive support element and furthermore at least one air cushion that is supported against the support element, at least in part, in a first region and that is attached to the at least one attaching device. Static friction and sliding friction are similar in magnitude, in particular between a casing of the air cushion and the first region of the support element, so that no slip-stick effect or stick-slip effect occurs and in particular generation of noise is prevented.

Such a lumbar support device has in particular a plurality of air cushions, wherein each of the air cushions can be filled with a desired quantity of air, usefully individually, and has a pressurization function. It is also possible to reduce the quantity of air in individual air cushions. To this end a controllable air supply is connected to the air cushions.

The air cushions typically have a casing made of a plastic film and an air input aperture and possibly a separate air outlet aperture. When the air cushions are being filled, the air cushions change in terms of their shape and support surface and/or their support region on the support element. The casing of the air cushion can slide along the support element, for example a few millimeters up to a few centimeters. According to the invention, the surface of the support element has the surface structure on the first region the casing of the air cushion slides along when the air cushion is filled and emptied.

The inventive seat, in particular motor vehicle seat, comprises an inventive lumbar support device. The lumbar support device is in particular arranged in a seatback of the seat.

### BRIEF DESCRIPTION OF THE FIGURES

The invention shall be described in greater detail in the following in addition with respect to further features and advantages using the description of exemplary embodiments and with reference to the enclosed drawings. In the drawing:

FIG. 1: depicts a support element;

FIG. 2: depicts a lumbar support device;

FIG. 3: depicts a surface structure of a support element; and,

FIG. 4A, 4B: illustrate a seat having a lumbar support device.

FIG. 1 depicts a support element 2 for a lumbar support device 30. The support element 2 comprises a plate-shaped body 4. The plate-shaped body 4 has a first side 6 and a second side 8. The first side 6 and the second side 8 oppose one another. The first side 6 supports one or a plurality of air cushions 32 that can be filled with air. In a lateral region, the plate-shaped body 4 has attaching devices 14 for the air cushions 32. The attaching devices 14 may project outward laterally, as shown, from the plate-like body 4 and may be arranged in pairs at a height. At least one region 10 on the first side 6 has a surface structure having a mean roughness Ra between 0.4 μm and 20 μm. Due to the elevated roughness in the first region 10, on which region the air cushion 32 can be supported, the friction, in particular the static friction, between air cushion and support element may be reduced and a slip-stick effect can be reliably and effectively prevented. The complete first side 6 usefully has a uniform surface structure because this is easier to produce in terms of process technology.

As is further depicted in FIG. 1, the support element 2 can have a plurality of through-holes 16 and/or further attaching elements 20 to which valve devices, for example, can be attached and/or through which lines can be passed. Moreover, the support element 2 can have guide elements 18, for example in the form of grooves, in which lines 34 of the lumbar support device 30 can be guided.

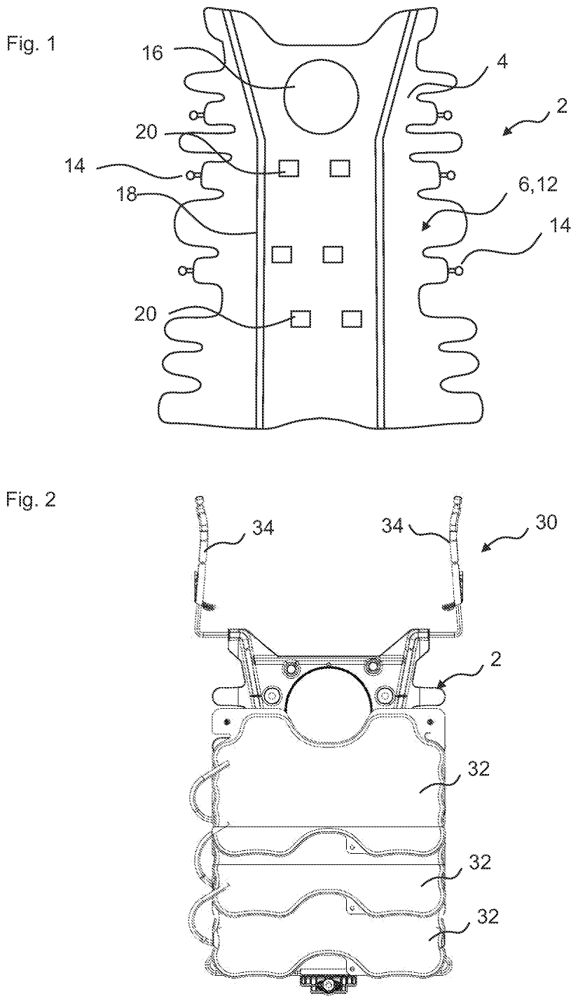

FIG. 2 depicts a lumbar support device 30 that has the support element 2 and air cushions 32 arranged on the support element 2. Furthermore depicted in FIG. 2 are two lines 34 that supply the air cushions 32 with compressed air or that permit air to be let out of the air cushions 32. Three air cushions 32 are depicted in the illustrated embodiment, wherein it is also possible to have more or fewer air cushions 32.

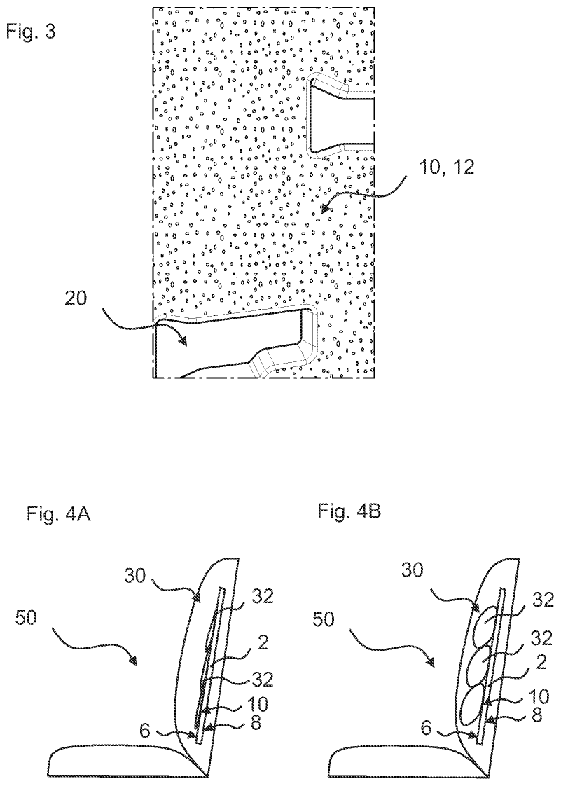

FIG. 3 depicts by way of example the surface roughness of the surface structure 12 in a first region 10. The structure element 2 in this case has a further attaching device 20 that is embodied as a through-hole and that is suitable for fastening in a further element, e.g. a clip.

FIGS. 4A and 4B depict a seat 50, e.g. a motor vehicle seat, with filled or unfilled air cushions 32. In FIG. 4A, the lumbar support device 30 is arranged in a seatback of the seat 50. The lumbar support device 30 comprises the support element 2, which extends along the seatback of the seat and is arranged on the side of the lumbar support device 30 facing away from the user.

Air cushions 32 are arranged on the side of the lumbar support device 30 facing the user. The support element 2 has a first side 6 that faces both the air cushions 32 and the user, and a second side 8 that opposes the first side 6. The air cushions 32 are supported on a first region 10 on the first side 6 of the support element 2. At least this first region 10 has the inventive surface structure.

FIG. 4B depicts the seat from FIG. 4A, now with filled air cushions 32. Because the air cushions 32 are filled, the air cushions are displaced relatively along the first side 6 and thus along the surface structure 12 in the first region 10. The air cushions 32 can slide on the first side 6 due to the inventive surface structure.

### LIST OF REFERENCE NUMBERS

2 Support element
4 Body
6 First side
8 Second side
10 First region
12 Surface structure
14 Attaching device
16 Through-hole
18 Guide element
20 Further attaching device
30 Lumbar support device
32 Air cushion
34 Line
50 Seat

1. A support element for a lumbar support device comprising:
a plate-like body having a first side and an opposing second side, wherein the first side supports at least one air cushion that can be filled with air, and
at least one attaching device for the at least one air cushion,
wherein the first side of the support element has a surface structure having a mean roughness Ra between 0.4 μm and 20 μm in a first region and/or or a surface modification that reduces static friction.

2. The support element according to claim 1, wherein the surface structure is embodied in one piece with the plate-like body.

3. The support element according to claim 1, the surface structure has a roughness between 1 μm and 20 μm, between 5 μm and 15 μm, or between 8 μm and 10 μm.

4. The support element according to claim 1, wherein the support element is formed from a plastic injection molded part, or from a one-component injection molded part.

5. The support element according to claim 1, wherein the first side of the support element has an equal mean roughness Ra in the first region and at least in part, or entirely, in a second region.

6. The support element according to claim 1, wherein the support element comprises attaching devices that project laterally from the plate-like body, and/or,
wherein a pair of attaching devices is provided for each air cushion.

7. The support element according to claim 1, wherein the support element has one or a plurality of guide elements for guiding lines to be connected to the at least one air cushion.

8. The support element according to claim 1, wherein the support element comprises one or a plurality of further attaching devices that are through-holes for adding further components of a lumbar support device and/or clips; and/or wherein the support element comprises one or a plurality of through-holes.

9. A lumbar support device for a seat, comprising the support element according to claim 1, the at least one air cushion is supported on the support element, at least in part, in the first region, and that is attached to the support element with the at least one attaching device.

10. A seat comprising the lumbar support device according to claim 9.
